(19) United States
(12) Patent Application Publication
(10) Pub. No.: US 2026/0080484 A1
(43) Pub. Date: Mar. 19, 2026

(54) SMART MANUFACTURING SYSTEMS AND METHODS FOR REAL-TIME TRACKING AND VALIDATION OF MANUAL ASSEMBLY TASKS

(71) Applicant: GM GLOBAL TECHNOLOGY OPERATIONS LLC, Detroit, MI (US)

(72) Inventors: Cory C. Wilson, Okemos, MI (US); Jeffrey A. Abell, Rochester Hills, MI (US); John P. Spicer, Plymouth, MI (US); Jorge F. Arinez, Rochester Hills, MI (US); Lu Huang, Troy, MI (US)

(73) Assignee: GM GLOBAL TECHNOLOGY OPERATIONS LLC, Detroit, MI (US)

(21) Appl. No.: 18/886,249

(22) Filed: Sep. 16, 2024

(51) Int. Cl. G06Q 50/04; G01S 1/04; G01S 5/00; G01S 5/02; G08B 7/06; G08B 21/24; H04W 4/029

(52) U.S. Cl. CPC G06Q 50/04; G01S 1/042; G01S 5/017; G01S 5/0294; G08B 7/06; G08B 21/24; H04W 4/029

(57) ABSTRACT

A method of operating a smart manufacturing system includes a beacon device borne by a user's appendage broadcasting beacon signals indicative of the appendage's location during assembly of a part within a manufacturing facility. A network of radio-frequency transceivers located within the manufacturing facility receives the beacon signals; a system controller uses the beacon signals to derive an appendage path with a stop location and stop time of the appendage when performing a manual task during part assembly. The controller retrieves a part-specific build plan that contains a predefined stop location and stop time for assembling the part. The controller detects a task error when the task's stop location differs from the predefined stop location and/or the task's stop time differs from the predefined stop time. Responsive to the detected error, the controller commands a system component to output an audible, visual, and/or tactile alert indicative of the task error.

### INTRODUCTION

The present disclosure relates generally to manufacturing systems for assembling products. More specifically, aspects of this disclosure relate to production line monitoring systems for tracking manual tasks during the assembly of automobiles.

Current production motor vehicles, such as the modern-day automobile, are assembled using a variety of different joining techniques, including bolting, crimping, welding, riveting, and clamping. Assembly line operators may be used in both manual and partially automated manufacturing systems to perform a variety of tasks at various stages of the production process. These line operators may be segregated into individual work cells to perform manual tasks or may work alongside robotic cells on the assembly line to facilitate or supervise automated tasks. As workpieces pass down the assembly line, each workpiece may be held within a jig or fixture to secure the workpiece in place to complete a single operation or a series of operations designated for that workstation. When a bolt, rivet, or clamp is installed on an assembly line, however, it can be difficult for the line operator to visually verify that the part was accurately mounted at a part-specific “target” location and installed to a part-specific “target” specification.

### SUMMARY

Presented below are smart manufacturing systems with attendant control logic for real-time tracking and validation of manual tasks during part-to-part assembly, methods for making and methods for operating such systems, and motor vehicles manufactured using such systems. In manual assembly processes, human-borne errors may occur due to the complexity or tedium of tasks at a given work station. Such complexity may be exacerbated with a mixed portfolio of products coming through the same work station. When a sequence of assembly tasks is performed by an operator at different locations, the operator may accidentally skip a step in the sequence and/or perform the sequence in the incorrect order. This has an even greater likelihood to occur when sequences are long and complicated and when multiple models or configurations of the product are made on the same assembly line. Therefore, it is beneficial to have systems that is able to identify when operators have missed steps or performed the steps in the wrong order. Modern production lines employ vision-based systems to monitor human assembly tasks; many of these systems, however, do not offer effective and automated error proofing procedures to confirm that an assembly worker has performed their designated tasks in the correct sequence. Presented below are smart manufacturing systems that employ wireless-enabled wearable devices and tool-mounted beacons in conjunction with an in-house network of radio-frequency (WiFi or ultra-wideband (UWB)) transceivers to track real-time movement of a user's appendage during a manual assembly task. In so doing, the manufacturing system is able to automatically inform the user of a build plan for a given part and confirm that the worker has performed the corresponding assembly tasks for that build plan in a predefined sequence. This system may also communicate with external tracking tools to collect data to improve operation efficiency and to provide quality assurance assessments.

Aspects of this disclosure are directed to monitoring control protocols and processor-executable control logic for tracking and validating manual tasks during part assembly in a manufacturing system. In an example, a method is presented for operating a smart manufacturing system for assembling a part by a user within a manufacturing facility, such as a line operator or technician of an automobile assembly line. This representative method includes, in any order and in any combination with any of the above and below disclosed options and features: transmitting, e.g., via a beacon device worn, held, or otherwise borne by a user's appendage, wireless beacon signals indicative of the appendage's locations during assembly of the part within the manufacturing facility; receiving, e.g., via a network of radio-frequency (RF) transceivers located within the manufacturing facility, the wireless beacon signals transmitted by the beacon device; determining, e.g., via a resident or remote microcontroller, central processor, control module, programmable logic device, or network of processors/controllers/modules/devices (collectively “system controller”), an appendage path including one or more stop locations, each with a corresponding stop time, of the user's appendage when performing a manual task during part assembly; retrieving, e.g., via the system controller from a resident or remote memory device, a part-specific build plan that contains one or more predefined stop locations, each with a corresponding stop time, for assembling the part; detecting, e.g., via the system controller, a task error when at least one of the task's stop locations does not coincide with its corresponding predefined stop location (e.g., within a preset location tolerance) and/or at least one of the task's stop times does not coincide with its corresponding predefined stop time (e.g., within a preset time tolerance); and outputting, e.g., via the system controller responsive to detecting the task error, one or more command signals to one or more system components to output one or more audible, visual, and/or tactile alerts indicative of the task error occurring when the user is performing the manual task.

Aspects of this disclosure are also directed to computer-readable media (CRM) containing controller-executable instructions for monitoring and verifying manual tasks performed during a part assembly operation. In an example, a non-transient CRM stores instructions that are executable by one or more processors of a system controller of a smart manufacturing system. The CRM-stored instructions, when executed by the processor(s), cause the system controller to perform operations, including: receiving, via a networked array of RF transceivers dispersed within a manufacturing facility, wireless beacon signals broadcast by a beacon device borne by an appendage of a user, the beacon signals being indicative of real-time locations/movement of the user's appendage during assembly of a part within the manufacturing facility; determining, using the received beacon signals, an appendage path with stop locations and corresponding stop times of the appendage when performing a manual task during assembly of the part; retrieving, from a memory device, a part-specific build plan delineating predefined stop locations and corresponding stop times for assembling the part; detecting, via the system controller, a task error responsive to any one of the task's stop locations not coinciding with a corresponding one of the predefined stop locations within a preset location tolerance (e.g., ±5cm or ±10cm) and/or any one of the task's stop times not coinciding with a corresponding one of the predefined stop times within a preset time tolerance (e.g., ±6 seconds (sec) or ±35 sec); and outputting, responsive to detecting the task error, a command signal to a system component to output an audible, visual, and/or tactile alert indicative of the task error when the user performs the manual task.

Additional aspects of this disclosure are directed to smart monitoring systems for tracking and validating manual tasks performed during a part assembly operation, such as the routing and bolting of a wiring harness to a vehicle chassis of an automobile. As used herein, the terms “vehicle” and “motor vehicle” may be used interchangeably and synonymously to include any relevant vehicle platform, such as passenger vehicles, commercial vehicles, industrial vehicles, off-road and all-terrain vehicles (ATV), motorcycles, farm equipment, aircraft, watercraft, spacecraft, etc. It is envisioned that disclosed error-proofing concepts may be applied to both automotive and non-automotive applications alike. In an example, a smart manufacturing system includes one or more beacon devices, each of which is borne by a user's appendage and transmits wireless beacon signals indicative of the appendage's locations during assembly of a part within a manufacturing facility. The manufacturing system employs an interconnected array of RF transceivers located within the manufacturing facility to receive the wireless beacon signals, a resident or remote memory device for storing part-calibrated build plans and user-related data, and a resident or remote system controller that aggregates, preprocesses, and analyzes the received beacon signals.

Continuing with the discussion of the foregoing example, the system controller communicates with the beacon device(s), memory device, and RF transceivers to receive the wireless beacon signals output by the beacon device(s) and, using this beacon signal data, derive an appendage path with one or more stop locations, each associated with a corresponding stop time, of the user's appendage when performing a manual task during assembly of the part. The system controller accesses the memory device to retrieve a part-specific build plan that contains one or more predefined stop locations, each with a corresponding stop time, for assembling the subject part. The controller detects a task error when: (1) one of the task's stop locations does not coincide with a corresponding one of the predefined stop location within a preset location tolerance; and/or (2) one of the task's stop times does not coincide with a corresponding one of the predefined stop times within a preset time tolerance. Responsive to detecting a task error, the system controller automatically transmits a command signal to a system component to output an audible, visual, and/or tactile alert indicative of the task error associated with the manual task.

For any of the disclosed systems, methods, and CRM, the system controller may determine a reduced-area work envelope at a workstation within the manufacturing facility within which the part is assembled, and determine from the wireless beacon signals when the user's appendage enters/moves in the work envelope. In this instance, the system controller may derive the appendage path in response to determining the user appendage is in the work envelope. As another option, the system controller may determine a part profile for the subject part, and overlay each predefined stop location onto the part profile. The system controller may then dynamically map each of the appendage's task stop locations to the predefined stop location overlayed onto the part profile. In this instance, the appendage path may include multiple task stop locations and, thus, the part-specific build plan may contain multiple predefined stop locations. The system controller may then dynamically map each of the appendage's task stop locations to a corresponding one of the predefined stop locations on the part profile. For each task stop location, the system controller may determine both: (1) an absolute location within the manufacturing facility (e.g., relative to a zero original location in the workstation), and (2) a relative location with respect to the associated build plan-defined stop location.

For any of the disclosed systems, methods, and CRM, the system controller may confirm that the manual task is complete when: (1) the appendage's task stop location coincides with the predefined stop location (e.g., within the preset location tolerance), and (2) the appendage's task stop time coincides with the predefined stop time (e.g., within the preset time tolerance). Responsive to detecting the task is complete, the system controller may automatically command one or more system components to output one or more audible, visual, and/or tactile alerts indicating that the manual task is complete. For instance, the system component may be a wearable electronic device that is worn on the user's appendage; the wearable electronic device may output a first alert warning a task error occurred, a second alert confirming a task stop location coincides with its corresponding predefined stop location, and a third alert notifying that the manual task is complete.

For any of the disclosed systems, methods, and CRM, the system component may output a task error (first) alert that indicates the user missed an assembly task, did not complete the assembly task, performed the assembly task in an incorrect order, duplicated the assembly task, and/or performed the assembly task for an improper amount of time. As a further option, the wireless-enabled beacon device may be mounted to a wearable electronic device that is worn on the user's appendage. In this instance, the system component may be the wearable electronic device such that one or more or all of the herein-described audible, visual, and/or tactile alerts is/are output in real-time by the wearable electronic device. Alternatively, the wireless-enabled beacon device may be mounted onto a tool held by the user's appendage for completing the manual task.

For any of the disclosed systems, methods, and CRM, the network of RF transceivers may collectively define a signal reception segment of a real-time localization system (RTLS) that is able to actively track real-time movement of the user's appendage with an accuracy of 25 centimeters (cm) or better or, in at least some applications, with an accuracy of 10 cm or better. While geolocation services, such as Global Positioning System (GPS) navigation and cellular trilateration, provide sufficient accuracy for locating larger objects (e.g., with an accuracy of approximately 2-5 meters), precision task tracking and validation will typically necessitate greater accuracy. In some instances, the network of RF transceivers may include an interconnected array of ultra-wideband or WiFi transceivers. Other available options for precision location tracking of a user's appendage may include BLUETOOTH® low-energy transceivers and RFID transceivers.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a schematic illustration of a representative smart manufacturing system for tracking and verifying completion of one or more manual tasks of a line operator in an assembly process in accordance with aspects of the present disclosure.

FIG. 2 is a schematic illustration of another representative smart manufacturing system for tracking and verifying completion of one or more manual tasks of a line operator in an assembly process in accordance with aspects of the present disclosure.

FIG. 3 is a flowchart illustrating a representative manufacturing control protocol for tracking and verifying completion of manual assembly tasks of a line operator, which may correspond to memory-stored instructions that are executable by a resident or remote microcontroller, control module, logic circuit, or other integrated circuit (IC) device or network of circuits/modules/microcontrollers/IC devices (collectively “controller”) in accordance with aspects of the present disclosure.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation. ” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,”or any logical combination thereof, for example.

Discussed below are novel monitoring systems for error proofing manual tasks during part-to-part assembly processes, e.g., confirming that the location, sequence, and duration of the tasks are correct with respect to the build manifest for each assembly. In an example, the monitoring system may include a wearable radio beacon that is worn by an operator and broadcasts wireless beacon signals on a periodic basis (e.g., every 100 milliseconds (ms)), one or more transceiver(s) capable of sending and receiving wireless signals on a periodic basis (e.g., every 10, 50, or 100 ms), and a computer system that determines and records real-time or near-real-time movement of the operator's appendage performing a manual assembly task or the tool being used to complete the manual task. Error proofing of a manual task may be achieved through indoor position localization of the appendage/tool via transceiver triangulation, received signal strength (RSS) techniques, or signal fingerprinting to map, register, and track different subjects in real-time. This system may be capable of: (1) mapping operator movement to their surrounding work environment and concurrently tracking operator hand position with respect to the assembly and corresponding task location(s); (2) mapping assembly location and profile to the work environment and tracking movement of the assembly on the production line; and/or (3) enabling assembly process registration to map task locations to the work environment and confirm a protocol (sequence) of required tasks for a particular operator at a particular workstation on the assembly line.

Disclosed monitoring systems for error proofing manual tasks during an assembly process may be capable of spatially and temporally mapping, registering, and tracking locations of operators, tasks, and target workpieces (e.g., vehicle assembly). Precision location tracking may be achieved through trilateration localization within a defined work “approximation” envelope inset within a manufacturing facility. Operator hand/tool location may be dynamically mapped inside the work envelope with respect to a location of a target workpiece. In an example, a line worker's real-time hand positions are tracked and mapped to the target workpiece's location and corresponding manual task locations for that workpiece. Absolute and relative locations of a target workpiece (e.g., vehicle assembly) may be dynamically tracked in a static or moving assembly line. Part-specific task locations and sequences may be monitored with respect to a planned operation protocol to confirm the initiation of each required task. Duration of a task at each location may be tracked to confirm the completion of each required task in the operation protocol.

Disclosed monitoring systems for error proofing manual tasks for assembly process quality control may be governed by a distributed computing network with one or more server-class workstations, one or more cloud-based servers, one or more random-access memory (RAM) devices, and one or more resident central processors. The computer system may provide an interactive, touchscreen graphical user interface (GUI) to communicate with users. The interactive touchscreen interface may include soft-touch controls (e.g., buttons, keyboards, dials, drop-down menus, etc.) for receiving user inputs and commands, such as current production plans, assembly protocols, process changes, etc. If desired, the computer system may send signals and data to the transceivers and beacons, including upcoming build variations or changes, current build plans (e.g., task location, sequence, duration, and tolerance data), etc. The computer system may receive and store signals and data from the transmitters, beacons, tools, and other data sources within the work environment, such as dynamic mapping of current operator hand position, absolute and relative locations, duration on current task, current location of target workpiece (e.g., vehicle assembly), etc. As another option, the computer system may make pass/fail decisions by conducting real-time processing and analysis of relevant data to compare the planned task location(s) with the actual task location(s), the planned task sequence with the actual task sequence, the planned task duration with the actual task sequence, etc. The computer system may store new and historical data to conduct post-processing and analysis of the stored data for process design and optimization.

It is envisioned that the wireless-enabled locator beacon may be affixed to an operator or to a tool held by an operator and may provide one-way or two-way communications between the beacon/operator and computer system. For two-way designs, the locator beacon may be integrated into a wearable electronic device that may communicate to the operator when the operator has missed a step, failed to complete a step in the assembly process, performed a step in the incorrect order, duplicated a step, committed a time delay at a step or between steps, etc. Likewise, the wearable electronic device may notify the operator of an upcoming build variant, new build protocol, warning of a task error, etc. For at least some implementations, the wearable device may generate sensory cues to notify the operator of the above-described communications. Visual cues, for example, may include colored indicators (e.g., red light: wrong location/duration/sequence; blue light: correct location; green light: task complete), which may be accompanied by audible cues (e.g., sounds/tones/beeps, voice narration/commands), and/or haptic cues (e.g., vibrations). The wearable device may be set in a training mode to guide an operator through a step-by-step tutorial for completing a particular series of tasks in a given assembly process for a target workpiece. As another option, the wearable device may receive operator inputs and feedback to improve system accuracy and performance (e.g., false negatives, error correction confirmation, etc.).

Additional and alternative hardware may enable additional functionality for disclosed monitoring systems to enhance quality assurance capabilities. The operator-worn wearable device and/or operator-held tool may be equipped with a select sensor or sensor array with integrated hardware for additional quality checks. Examples of such add-on hardware may include a laser imaging array, single or multiple cameras, etc., for vision-based inspection. A microphone may be utilized for sound-based verifications, an inertial measurement unit (IMU) may be employed for deriving orientation information, a dynamics sensor (e.g., accelerometer) may be employed for deriving pitch, roll, yaw, acceleration/deceleration, etc. As a further option, the transceiver or beacon may communicate with and collect data from one or more external tools that are compatible for quality checks, such as collecting torque data from a smart torque wrench that is compared to torque specifications at different task locations.

Disclosed monitoring systems for error proofing manual tasks during an assembly process may include a data feedback loop that is employed for quality evaluation and process optimization. Collected data may be used, for example, to evaluate the efficiency of an assembly operation by documenting individual task durations and accrued durations that an operator or operators spend at different tasks for a given assembly operation. Operation efficiency may be correlated to the quality of the assembly and may collectively provide feedback for process and workforce optimization. For example, a “most efficient” job protocol may be derived along with a set of “optimal” operator skills that may be identified and used for training purposes. System accuracy and robustness may be monitored and optimized through this feedback loop. For example, the size of a location envelope, which may be used to approximate a defined location, may be optimized based on dynamic mapping of operator/task location and operator feedback data. The feedback loop may be supported by machine learning and artificial intelligence models.

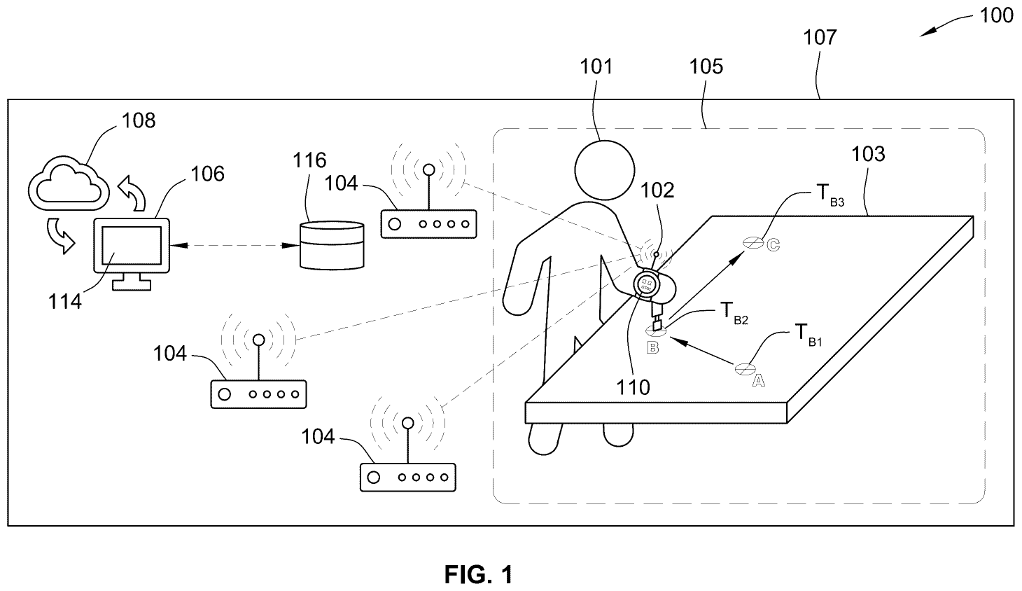

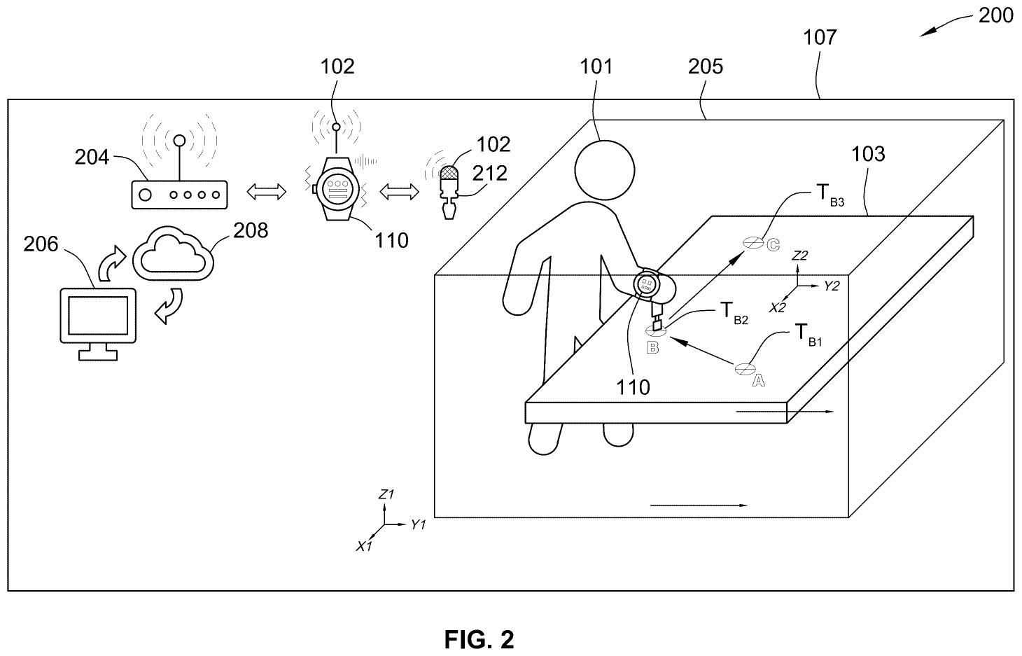

Referring now to the drawings, wherein like reference numbers refer to like features throughout the several views, there are shown in FIGS. 1 and 2 examples of smart manufacturing systems, which are respectively designated at 100 and 200 and portrayed herein for purposes of discussion as automated continuous-flow production lines for assembling automobiles. The illustrated smart manufacturing systems 100 and 200—also referred to herein as “monitoring system” or “error-proofing system”—are merely exemplary applications with which aspects of this disclosure may be practiced. In the same vein, implementation of the present concepts for error-proofing manual bolt installation for assembly of an automobile should also be appreciated as a non-limiting implementation of disclosed features. As such, it will be understood that novel features of this disclosure may be used to error proof installation of assorted parts for assorted assemblies, may be incorporated into any logically relevant type of manufacturing system, and may be employed for both automotive and non-automotive applications alike. Moreover, only select components of the smart manufacturing systems are shown and will be described in detail herein. Nevertheless, the manufacturing systems discussed below may include numerous additional and alternative features, and other available peripheral hardware, for carrying out the various methods and functions of this disclosure.

The smart manufacturing system 100 of FIG. 1 is designated for assembling a target workpiece (“part”) within a manufacturing facility by a qualified user, such as a line operator 101 bolting a vehicle component 103 at a designated workstation 105 on a vehicle production line within an automobile assembly plant 107. While shown with a single user performing a single task as part of a single assembly operation on a single part, it is envisioned that the smart manufacturing systems 100 and 200 may be scaled and adapted for accommodating multiple users to perform a variety of different tasks on similar or distinct parts as part of any number of manufacturing operations. By way of example, the line operator 101 of FIG. 1 may be tasked with welding, riveting, clamping, or crimping the vehicle component 103, the line operator 101 may be working in tandem with another worker or a robotic cell within the same workstation 105, and the line operator 101 may perform a series of tasks on multiple target workpieces or complete multiple assembly operations on a single workpiece. Although differing in appearance, it is envisioned that any of the options and features described herein with reference to the smart manufacturing system 100 of FIG. 1 may be incorporated, singly or collectively, into the system 200 of FIG. 2, and vice versa. For brevity and efficiency, like elements are labelled with like reference numbers in these two Figures; unless explicitly stated to the contrary, features and options described for one Figure may be incorporated into the other.

With continuing reference to both FIGS. 1 and 2, the smart manufacturing system 100 and 200 may be typified by three interoperable subsystems: (1) a locator beacon 102 subsystem, (2) a wireless transceiver 104, 204 subsystem, and (3) a line-side or back office (BO) central computer 106, 206 control subsystem with a host cloud computing service 108. The locator beacon 102 is a wireless-enabled portable beacon device that is borne by one of the user's appendages, such as the user's arms, wrists, or hands. For instance, the locator beacon 102 may be integrated into a wearable electronic device (e.g., smartwatch 110 of FIG. 1) that is worn on the user's wrist or may be tethered to a tool (e.g., smart torque wrench 212 of FIG. 2) that is carried by the user's hand. When activated, the locator beacon 102 may broadcast a wireless RF signal at a predefined frequency and wavelength within a unique beacon frame on a periodic basis (e.g., every 100 milliseconds (ms)). These beacon signals indicate the real-time locations and movement of the user's appendage within the manufacturing facility 107. It may be desirable that the locator beacon 102 be a rechargeable, battery-powered device that is compact, waterproof, and durable (e.g., shock proof). Indoor position localization may be accomplished using an active BLUETOOTH® transceiver, a UWB transponder, or a WiFi tag. Unlike traditional smartphones, tablet computers, and laptop computers, which rely on hard-lined location tracking or GPS/cellular geopositioning with minimal localization accuracy (e.g., 2-5 meters), disclosed techniques use indoor positioning system architectures to provide precision accuracy (e.g., to within a few centimeters) of a line operator's hand that is performing a manual assembly task.

The smart manufacturing system 100 of FIG. 1 also utilizes a precision position recognition subsystem to actively track real-time or near-real-time positioning of the user-borne locator beacon 102 and, thus, the user's appendage while performing a manual task or series of tasks inside the operator workstation 105. While not per se limited, the position sensing subsystem may be typified by a communicatively interconnected “network” of wireless transceivers 104 (FIG. 1) that collaborate with the locator beacon 102 to generate position data indicative of the user appendage's real-time position and, if desirable, real-time movement and orientation. For at least some applications, each position sensing transceiver 104 may be a wireless radio-frequency (RF) receiver/transceiver that receives wireless RF signals from a beacon and, optionally, transmits RF signals to a wireless RF transmitter/transceiver tether that is mounted on or inside a wearable worn by or a tool held by the user. The signals used for communication amongst different components of this system 100, 200 may be ultra-wideband (UWB) frequency radio waves, BLUETOOTH® compliant radio waves, Wi-Fi, etc. One non-limiting example of suitable beacon signal format may include a UWB 3.1-106 GHz signal with a transmission power of 0.5 mW/41.3 dBM/mHz, a range of 10-150 m, a data rate of 110kbit/sec-6.8mbit/s, a spatial resolution of 10 cm, and minimal interference in an indoor (industrial/factory) setting.

Using the wireless beacon signals received by a networked array of three or more UWB/WiFi wireless transceivers 104 of FIG. 1, the line-side computer 106 terminal may triangulate the real-time device positions of the locator beacon 102 and, thus, the appendage bearing the beacon device while performing tasks on the vehicle component 103. Conversely, the BO central computer 206 of FIG. 2 may employ RSS or signal fingerprinting techniques to evaluate periodic beacon signals broadcast from the smartwatch 110 or smart tool 212 and received by a dedicated WiFi/BLUETOOTH® transceiver 204 of FIG. 2 to map, register, and track user movement. The wireless transceivers 104 may take on a variety of suitable form factors, including a multi-band small form-factor pluggable (SFP) UWB transmitter/receiver that is capable of receiving and, if desired, sending predefined signals on a frequent and regular basis (e.g., every 0.1 sec.). It should be appreciated that the number, arrangement, and type of signal transceivers employed for precision location tracking may be varied from that which are shown in the drawings to accommodate various intended applications.

System monitoring and validation may be enabled by a line-side (resident) computer 106 terminal (FIG. 1) or a BO (remote) BO server-class computer 206 station (FIG. 2) that provides a mixture of services, both individually and through its communication with other networked devices. The line-side or BO central computer 106, 206 control subsystem may be generally composed of one or more processors, each of which may be embodied as a discrete microprocessor, an application specific integrated circuit (ASIC), or a dedicated control module. The manufacturing systems 100, 200 of FIGS. 1 and 2 may offer workstation control via the line-side computing terminal 106 and/or centralized system control via the BO server-class computing station 206. Each computing control subsystem may include a touchscreen display device 114, which enables bidirectional communication with the line operator 101, and one or more electronic memory devices 116, each of which may take on the form of a CD-ROM, magnetic disk, integrated circuit (IC) device, a solid-state drive (SSD) memory, a hard-disk drive (HDD) memory, flash memory, semiconductor memory (e.g., various types of RAM or ROM), etc.

Central computer 106, 206 control subsystem of FIGS. 1 and 2 may provision data aggregation, preprocessing, analysis, and storage of real-time location data of the line operator(s) 101 at a preset interval in time (e.g., ˜1 sec.). By analyzing this data, the line-side or BO central computer 106, 206 may evaluate the individual locations, task sequence, and individual task durations of the manual assembly tasks performed by the line operator(s) 101 to confirm they are correct with respect to a part-specific build manifest tailored to the vehicle component 103. The computer system may serve as a central “brain” of the system with capabilities including: providing an interactive and modifiable GUI for inputs and outputs; sending signals to the transmitters or beacons for information, notifications, and warnings; and receiving and storing signals and data from the transmitters or beacons for real-time or post data processing and decision making.

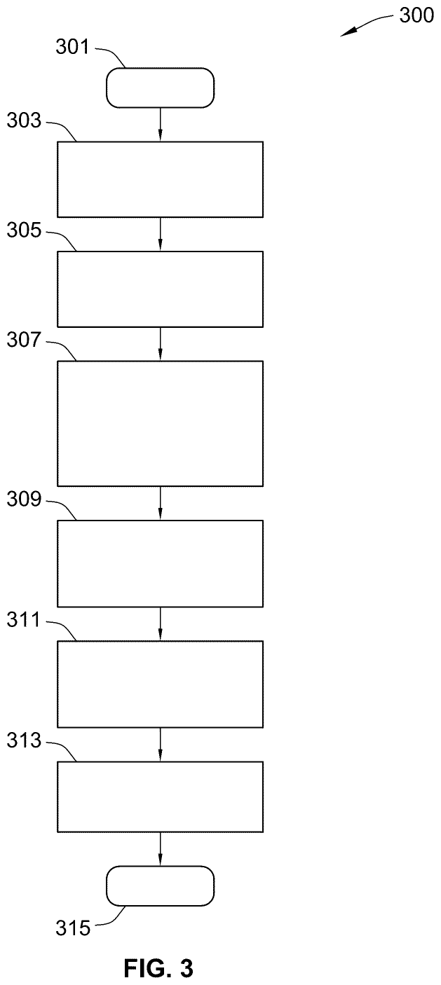

With reference next to the flow chart of FIG. 3, an improved method or control protocol for tracking and verifying completion of a manual task by a user on a target workpiece, such as the sequence of bolting tasks T_{B1}-T_{B3} performed by the assembly line operator 101 of FIG. 1 on the vehicle component 103, is generally described at 300 in accordance with aspects of the present disclosure. Some or all of the operations illustrated in FIG. 3 and described in further detail below may be representative of an algorithm that corresponds to non-transitory, processor-executable instructions that are stored, for example, in main or auxiliary or remote memory (e.g., resident system memory device 116 of FIG. 1 or remote cloud computing service 208 database of FIG. 2). These instructions may be executed, for example, by an electronic controller, processing unit, dedicated control module, logic circuit, or other module or device or network of controllers/modules/devices (e.g., line-side computer terminal 106 of FIG. 1 or BO server-class computer station 206 of FIG. 2), to perform any or all of the above and below described functions associated with the disclosed concepts. It should be recognized that the order of execution of the illustrated operation blocks may be changed, additional operation blocks may be added, and some of the herein described operations may be modified, combined, or eliminated.

Method 300 begins at START terminal block 301 of FIG. 3 with memory-stored, processor-executable instructions for initializing a part-to-part assembly procedure with an integrated fastener installation error proofing control protocol. This routine may be initialized in real-time, near real-time, continuously, systematically, sporadically, and/or at predefined time intervals, for example, each 10 or 100 milliseconds during use of the operator workstation 105. As yet another option, terminal block 301 may initialize responsive to a user command prompt (e.g., input via line-side computer terminal 106), a central control prompt (e.g., output via BO server-class computing station 206), or a broadcast prompt signal received from an off-site manufacturing quality control service (e.g., disseminated by remote cloud computing service 208). Upon completion of some or all of the control operations presented in FIG. 3, method 300 may advance to END terminal block 315 and temporarily terminate or, optionally, may loop back to terminal block 301 and run in a continuous loop.

Advancing from terminal block 301 to LOCATOR BEACON data output block 303, one or more locator beacons transmit wireless beacon signals during a manual assembly task performed by a user. Referring again to the example implementation of FIG. 1, the locator beacon device 102 integrated into the smartwatch 110 worn on the line operator's wrist may continually broadcast wireless beacon signals indicative of the appendage's location during assembly of the vehicle component 103 within the assembly plant 107. To preserve battery life and reduce processing load, the beacon device 102 may be programmed to default to a low-power “sleep mode”; the device may be “awakened” by the monitoring system upon detected entry of the locator beacon 102 into a predefined work envelope 205 at the operator's workstation 105 within the assembly plant 107.

In tandem with the locator beacon broadcasting wireless signals, one or more networked transceivers located within the manufacturing facility receives the wireless beacon signals and concomitantly transmits the received signals to a designated system controller, as indicated at WIRELESS TRANSCEIVER data input block 305. The networked array of RF transceivers 104 of FIG. 1, for example, collectively define a signal reception segment of a real-time localization system (RTLS) that inputs the beacon signals output by the locator beacon 102. Using these signals, the central “brain” section of the RTLS—the line-side or BO central computer 106, 206—is able to track real-time movement of the user's appendage with an accuracy of 25 cm or better or, in at least some applications, with an accuracy of 10 cm or better. The locator beacon 102 may be a UWB tag that emits short-pulse RF signals that include ID, timestamp, and time-of-flight (ToF) data; the RF transceivers 104 may be UWB receiver modules arranged in a predefined (triangular) array with, ideally, an unobstructed “line of sight” to the beacon.

Upon receipt of the wireless beacon signals, a resident or remote system controller aggregates, preprocesses, and analyzes the signal data at LOCATION TRACKING subroutine block 307 to determine and record real-time locations of the user's appendage when performing a manual task during assembly of the part. Line-side computer terminal 106 of FIG. 1 or BO central computer 206 of FIG. 2, for example, may collect a time series of location data from the RF transceivers 104; the data may be “cleaned” by removing noise, outliers, anomalies, etc. Advancing to PATH PREDICTION subroutine block 309, the cleaned data may be fused, triangulated, and analyzed to derive a two-dimensional (2D) or three-dimensional (3D) predicted path of the line operator's hand as it traverses to a first bolting task T_{B1}, from the first bolting task T_{B1} to a second bolting task T_{B2}, and from the second bolting task T_{B2} to a third bolting task T_{B3}. The predicted path may contain discrete stop locations for each task T_{B1}-T_{B3}, respective stop times (“durations”) for each task T_{B1}-T_{B3}, and a path sequence taken by the operator for completing the three tasks each task T_{B1}-T_{B3}. To reduce processing load and storage burden, the computer terminal 106, 206 may call-up or dynamically create a work envelope (e.g., work envelope 205 of FIG. 2) at the operator's workstation within which the vehicle component 103 is assembled; location data processing and storage may be disabled when the operator 101 is outside this work envelope. Upon determining that the line operator 101 or, more importantly, their beacon-wearing appendage has entered the work envelope, the computer terminal 106 may automatically begin collecting, processing, and analyzing location data to generate the associated appendage path.

With continuing reference to FIG. 3, method 300 advances from subroutine block 309 to TASK ERROR decision block 311 to determine whether or not an error occurred while the user is performing the manual tasks associated with assembling the target workpiece. To perform the task error assessment, the line-side computer 106 or BO central computer 206 terminal may access resident system memory device 116 of FIG. 1 or remote cloud computing service 208 database of FIG. 2 to retrieve a part-specific build plan (e.g., original equipment manufacturer (OEM) build manifest) customized for assembling the vehicle component 103. This build plan may contain part identification information (e.g., weight, dimensions, origin, destination, etc.), handling instruction, and instructions for completing the bolting tasks T_{B1}-T_{B3}, including a set of predefined stop locations with associated stop times, stop sequence, and manufacturing tolerances.

At this juncture, the line-side computer terminal 106 or BO central computer 206 may access the system memory device 116 of FIG. 1 or cloud computing service 208 database to retrieve a part-specific profile for the vehicle component 103 (e.g., 3D part CAD model). If not already contained in the retrieved profile data, the line-side computer 106 may overlay the build-plan defined stop locations onto the part profile. As the operator moves from one manual task to the next (e.g., from the first bolting task T_{B1} to the second bolting task T_{B2}), the line-side computer 106 may map the manually performed task locations with respect to their corresponding predefined stop locations that are overlayed onto the part profile. In FIG. 1, the line operator's manual task path includes multiple task stop locations in accordance with the stop locations defined in the build plan; each manual task stop location is mapped to a respective one of the predefined stop locations on the part profile. For each manual task's stop location, the line-side computer 106 may concurrently derive both an absolute location within the assembly plant 107 and a relative location with respect to its corresponding build plan-defined stop location.

TASK ERROR decision block 311 of FIG. 3 may also provide processor-executable instructions for determining if each task was properly completed (“task complete”) or, conversely, if a task was not properly completed (“task error”). A task error may be detected for a particular manual assembly task in response to: (1) its task stop location not substantially coinciding with the corresponding build plan-defined stop location (e.g., within a preset location tolerance of ±2cm); and/or (2) its task stop time not substantially coinciding with the corresponding build plan-defined stop time (e.g., within a preset time tolerance of ±6 sec). Where applicable, a task error may also be detected when the line operator 101 has performed their designated manual tasks of a subject assembly operation in the incorrect sequence. For each task error, an error flag may be set in system memory 116 along with associated task data (e.g., date, time, workstation ID, operator ID, part ID, etc.). It is also envisioned that the line operator 101 may be given a user-selectable option, e.g., via touchscreen display device 114 or similarly suitable human-machine interface (HMI) to override a task error, e.g., as a false-negative result.

Upon detection of a task error, the line-side computer 106 or BO central computer 206 may execute ERROR ALERT data output block 313 and transmit a command prompt to a select system component or components to generate a predetermined (first) audible, visual, and/or tactile alerts indicating a task error occurred when the line operator 101 was performing their manual task(s). By way of example, and not limitation, the operator's smartwatch 110 may be prompted to generate a warning beep attendant with a red alert LED to notify them of the task error. As another option, the operator's smartwatch 110 may output an audible/visual/tactile alert in real-time to notify the line operator 101 as each task error occurs. Moreover, the touchscreen display device 114 may display an alert that indicates the operator missed an assembly task, did not complete an assembly task, performed a series of assembly tasks in an incorrect order, duplicated an assembly task, or performed an assembly task for an improper amount of time.

In contrast to detecting a task error, a task may be confirmed as properly completed (“validated”) in response to: (1) the task's stop location coinciding with its corresponding build plan-defined stop location (e.g., within the preset location tolerance), and (2) the task's stop time coinciding with its corresponding build plan-defined stop time (e.g., within the preset time tolerance). Upon confirming that the task was properly completed (task complete), the line-side computer 106 or BO central computer 206 may responsively transmit a command prompt to a select system component or components to generate a predetermined (second) audible, visual, and/or tactile alert indicating the task is complete. For instance, the line operator's smartwatch 110 may output a single chime attendant with a blue alert when the task's stop location coincides with its predefined stop location, and may output a double chime attendant with a green LED when the manual task is complete within its designated duration. At this juncture, the method 300 may proceed to terminal block 315 and temporarily terminate.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of operating a smart manufacturing system for assembly of a part by a user within a manufacturing facility, the method comprising:
transmitting, via a beacon device borne by a user appendage of the user, wireless beacon signals indicative of appendage locations of the user appendage during assembly of the part within the manufacturing facility;
receiving, via a radio-frequency (RF) transceiver located within the manufacturing facility, the wireless beacon signals transmitted by the beacon device;
determining, via a system controller using the wireless beacon signals, an appendage path including a task stop location and a task stop time of the user appendage when performing a manual task during assembly of the part;
retrieving, via the system controller from a memory device, a part-specific build plan including a predefined stop location and a predefined stop time for assembling the part;
detecting, via the system controller, a task error when the task stop location does not coincide with the predefined stop location within a preset location tolerance and/or the task stop time does not coincide with the predefined stop time within a preset time tolerance; and
outputting, via the system controller responsive to detecting the task error, a first command signal to a system component to output a first audible, visual, and/or tactile alert indicative of the task error when performing the manual task.

2. The method of claim 1, further comprising:
determining a work envelope at a workstation within the manufacturing facility within which the part is assembled; and
determining, via the system controller using the wireless beacon signals, when the user appendage is in the work envelope,
wherein determining the appendage path via the system controller is in response to determining the user appendage is in the work envelope.

3. The method of claim 1, further comprising:
determining a part profile of the part;
overlaying the predefined stop location onto the part profile; and
mapping the task stop location of the user appendage with respect to the predefined stop location overlayed onto the part profile.

4. The method of claim 3, wherein the appendage path includes a plurality of the task stop locations, the part-specific build plan includes a plurality of the predefined stop locations, and mapping the task stop location includes mapping each of the task stop locations to a corresponding one of the predefined stop locations on the part profile.

5. The method of claim 4, further comprising determining, via the system controller for each of the task stop locations, an absolute location relative to an original position within the manufacturing facility and/or a relative location with respect to the corresponding one of the predefined stop locations.

6. The method of claim 1, further comprising:
detecting, via the system controller, a task complete when the task stop location coincides with the predefined stop location within the preset location tolerance and the task stop time coincides with the predefined stop time within the preset time tolerance; and
outputting, via the system controller responsive to detecting the task complete, a second command signal to the system component to output a second audible, visual, and/or tactile alert indicative of the task complete.

7. The method of claim 6, wherein the system component is a wearable electronic device worn by the user appendage of the user, the method further comprising:
outputting, via the wearable electronic device, a third audible, visual, and/or tactile alert when the task stop location coincides with the predefined stop location; and
outputting, via the wearable electronic device, the second audible, visual, and/or tactile alert when the manual task is complete.

8. The method of claim 1, wherein the first audible, visual, and/or tactile alert output by the system component indicates the user missed an assembly task, did not complete the assembly task, performed the assembly task in an incorrect order, duplicated the assembly task, and/or performed the assembly task for an improper amount of time.

9. The method of claim 1, wherein the beacon device is mounted to a wearable electronic device worn by the user appendage of the user.

10. The method of claim 9, wherein the system component is the wearable electronic device, and wherein the first audible, visual, and/or tactile alert is output in real-time by the wearable electronic device to notify the user of the task error.

11. The method of claim 1, wherein the beacon device is mounted to a tool held by the user appendage of the user for performing the manual task during assembly of the part.

12. The method of claim 1, wherein the RF transceiver includes a network of RF transceivers collectively defining a signal reception segment of a real-time localization system (RTLS) configured to track real-time movement of the user appendage with an accuracy of 25 centimeters (cm) or better.

13. The method of claim 12, wherein the network of RF transceivers includes an interconnected array of ultra-wideband (UWB) or WiFi transceivers.

14. A non-transient, computer-readable medium storing instructions executable by a system controller of a smart manufacturing system for assembly of a part by a user within a manufacturing facility, the instructions, when executed, causing the system controller to perform operations comprising:
receiving, via a networked array of radio-frequency (RF) transceivers dispersed within the manufacturing facility, wireless beacon signals transmitted by a beacon device borne by a user appendage of the user, the wireless beacon signals being indicative of appendage locations of the user appendage during assembly of the part within the manufacturing facility;
determining, using the received wireless beacon signals, an appendage path including task stop locations associated with respective task stop times of the user appendage when performing a manual task during assembly of the part;
retrieving, from a memory device, a part-specific build plan delineating predefined stop locations associated with respective predefined stop times for assembling the part;
detecting, via the system controller, a task error responsive to any one of the task stop locations not coinciding with a corresponding one of the predefined stop locations within a preset location tolerance and/or any one of the task stop times not coinciding with a corresponding one of the predefined stop times within a preset time tolerance; and
outputting, responsive to detecting the task error, a command signal to a system component to output an audible, visual, and/or tactile alert indicative of the task error when performing the manual task.

15. A smart manufacturing system for monitoring assembly of a part by a user within a manufacturing facility, the smart manufacturing system comprising:
a beacon device configured to be borne by a user appendage of the user and transmit wireless beacon signals indicative of appendage locations of the user appendage during assembly of the part within the manufacturing facility;
a radio-frequency (RF) transceiver configured to locate within the manufacturing facility and receive the wireless beacon signals transmitted by the beacon device; and
a system controller communicatively connected to the RF transceiver and the beacon device, the system controller being programmed to:
receive, via the RF transceiver, the wireless beacon signals transmitted by the beacon device;
determine, using the received wireless beacon signals, an appendage path including a task stop location and a task stop time of the user appendage when performing a manual task during assembly of the part;
retrieve, from a memory device, a part-specific build plan including a predefined stop location and a predefined stop time for assembling the part;
detect a task error when the task stop location does not coincide with the predefined stop location within a preset location tolerance and/or the task stop time does not coincide with the predefined stop time within a preset time tolerance; and
responsive to detecting the task error, output a first command signal to a system component to output a first audible, visual, and/or tactile alert indicative of the task error when performing the manual task.

16. The smart manufacturing system of claim 15, wherein the system controller is further programmed to:
detect a task complete when the task stop location coincides with the predefined stop location within the preset location tolerance and the task stop time coincides with the predefined stop time within the preset time tolerance; and
responsive to detecting the task complete, output a second command signal to the system component to output a second audible, visual, and/or tactile alert indicative of the task complete.

17. The smart manufacturing system of claim 16, wherein the system component is a wearable electronic device worn by the user appendage of the user, and wherein the wearable electronic device is configured to:
output a third audible, visual, and/or tactile alert when the task stop location coincides with the predefined stop location; and
output the second audible, visual, and/or tactile alert when the manual task is complete.

18. The smart manufacturing system of claim 15, wherein the system component is a wearable electronic device worn by the user appendage of the user, the beacon device is mounted to the wearable electronic device, and the first audible, visual, and/or tactile alert is output in real-time by the wearable electronic device to notify the user of the task error.

19. The smart manufacturing system of claim 15, wherein the beacon device is mounted to a tool held by the user appendage of the user for assembly of the part.

20. The smart manufacturing system of claim 15, wherein the RF transceiver includes a network of RF transceivers collectively defining a signal reception segment of a real-time localization system (RTLS) configured to track real-time movement of the user appendage with an accuracy of 25 centimeters (cm) or better.
